(19) United States
(12) Patent Application Publication
(10) Pub. No.: US 2007/0199497 A1
(43) Pub. Date: Aug. 30, 2007

(54) Sailboat tiller

(75) Inventors: Paul Bedell, Long Buckby (GB); Paul Adkins, Newton Longville (GB)

Correspondence Address: K.F. ROSS P.C., 5683 RIVERDALE AVENUE, SUITE 203 BOX 900, BRONX, NY, 10471-0900, US

(73) Assignee: VELUM LIMITED

(21) Appl. No.: 11/700,549

(22) Filed: Jan. 31, 2007

(30) Foreign Application Priority Data
Feb. 1, 2006 (GB) 0601965.7

(51) Int. Cl. G05D 1/02; B63H 25/04

(52) U.S. Cl. 114/144 R

(57) ABSTRACT

A carbon fibre sailboat tiller, in particular for a sailboat having a traveller rope which passes across the tiller, has a midsection comprising an elongate, rounded ridge on its upper surface and a corresponding, inverted V-shaped groove on its lower surface. The ridge defines a ramped profile which minimises interference with the traveller block assembly, while the groove defines re-entrant surfaces which stiffen the tiller and allow its vertical profile as well as its clearance from the deck to be reduced. Preferably the midsection of the tiller is widened laterally, and the ridge and recess extend for between 50% and 67% of the total length of the tiller.

### FIELD OF THE INVENTION

This invention relates to tillers for boats, and in particular for sailboats such as Laser (RTM) sailboats having a traveller rope which passes over the tiller between the gunwhales.

### BACKGROUND OF THE INVENTION

In sailboats such as yachts and dinghies the tiller is an elongate, generally horizontal bar which is fixed at its proximal end to the rudder and extends forward to the cockpit. A simple handle or, alternatively, an articulated extension rod fixed to the distal end of the tiller allows the user to swing the tiller in a generally horizontal arc and so control the position of the rudder.

In certain formula Laser (RTM) and similar sailboats, the stern of the boat comprises a broad, flat deck over which the tiller passes. A pair of fairleads are fixed to the deck at the gunwhales, and a so-called traveller rope is looped around the fairleads so that its standing part passes across the deck and over the tiller. The ends of the traveller rope are led forward beneath the tiller, and one end is provided with an eye through which the second end is passed. A cleat is fixed to the deck aft of the cockpit and just beneath the distal end of the tiller, and the second, free end of the traveller rope is hauled tight so as to tension its standing part and retained by the cleat. The distal end of the boom is controlled by a mainsheet which passes around a traveller block assembly, which in turn runs freely along the standing part of the traveller rope between the gunwhales.

In order to obtain optimal performance from the sail, particularly in racing, it is found to be important to apply as much tension as possible to the traveller rope, which preferably is made from a low stretch material, so that it lies as flat as possible and the traveller block assembly is retained as close as possible to the deck. However, the tension in the traveller rope also applies downward pressure to the tiller, and causes the traveller block assembly to impact against the tiller as it moves across it.

In order to allow the traveller rope to lie as flat as possible, and to minimise interference between the traveller block assembly and the tiller, the tiller is preferably formed with as low a profile, i.e. as little vertical height, as possible, and is also arranged as close as possible to the deck. The reduced vertical thickness of the tiller however results in a commensurate reduction in its stiffness, which may result in it deflecting in use so as to foul the deck or the traveller rope cleat at its distal end.

In order to achieve an optimal balance of low weight, low profile and maximum rigidity, traditional tillers made from wooden spars of round, oval or rectilinear cross section have been largely replaced by tillers made from aluminium sections or, more preferably, as hollow sections moulded from carbon fibre. Carbon fibre tillers for Laser (RTM) sailcraft are currently available for example from Annapolis Performance Sailing Ltd. of Annapolis, Md., USA (www.apsltd.com), and include the WinDesign Carbon Laser Tiller (™); the Rooster Sailing Carbon Laser Tiller (™) from Rooster Sailing of Emsworth, Hampshire, United Kingdom; and the Black Diamond Laser Tiller (™) from Acme Carbon (www.acmecarbon.com). Many currently available carbon fibre tillers incorporate a wear plate made from stainless steel or titanium which protects the tiller where it contacts the traveller rope and traveller block assembly.

### OBJECT OF THE INVENTION

While the use of carbon fibre has made it possible to form hollow tillers having a better combination of high stiffness, low weight and low profile while minimising the damaging impact of the traveller block assembly against the tiller, it is still found problematic to optimise all of these conflicting requirements, and it is the object of the present invention to provide an improved tiller which better meets all of these abovementioned objectives.

### SUMMARY OF THE INVENTION

According to the present invention there is provided a tiller as defined in the appended claims.

The axially elongate recess in the lower side of the tiller midsection provides additional, re-entrant surfaces which significantly stiffen the midsection, particularly in a hollow carbon fibre construction, and this additional stiffness enables the vertical profile of the tiller to be reduced. At the same time, the upper surface of the ridged tiller midsection forms a ramp which guides the traveller block assembly smoothly over the tiller, while its narrow lower edges engage the base of the traveller block as close as possible to the deck, minimising impact.

By horizontally widening the tiller midsection, the angle of the sloping upper surfaces may be advantageously reduced, which still further reduces the impact of the traveller block assembly against the tiller.

### BRIEF DESCRIPTION OF THE DRAWINGS

Further features and advantages will become apparent from the following description in which an illustrative embodiment is set forth, purely by way of example and without limitation to the scope of the invention, and with reference to the accompanying figures, in which:

FIG. 1 shows a tiller in accordance with a first embodiment, installed on a sailboat; and

FIGS. 2A-2E are various perspective views of the tiller of FIG. 1.

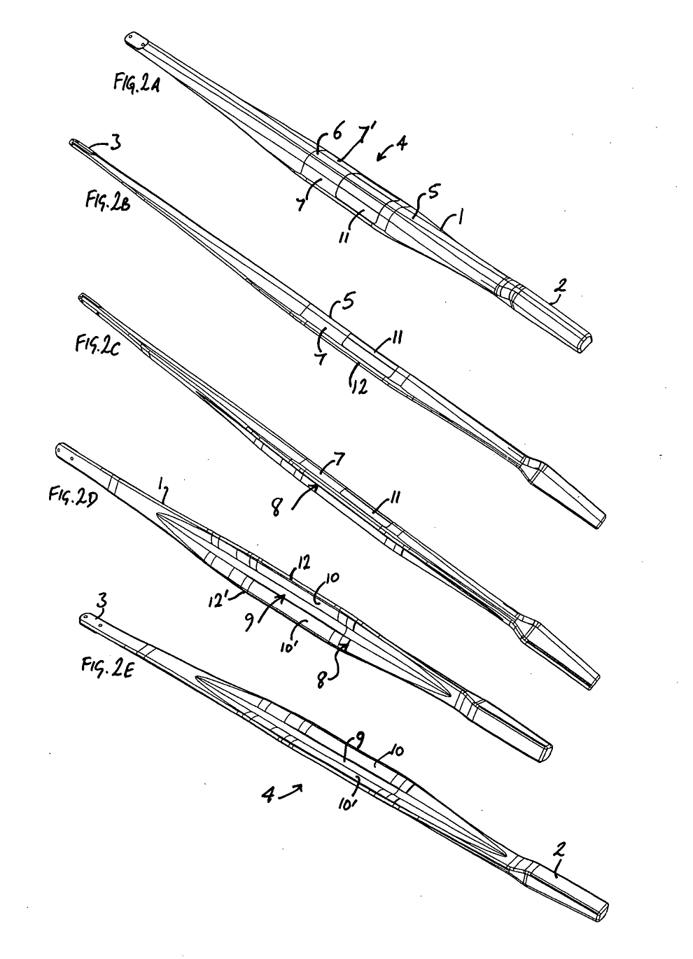

### DESCRIPTION OF THE PREFERRED EMBODIMENT

Referring to all of the Figures, in a first embodiment a tiller 1 comprises an elongate bar having a proximal end 2, a distal end 3, and a midsection 4. The proximal end 2 is adapted for attachment to the rudder 21 of a boat 20, in the present example being shaped to fit inside a mounting 22 on the upper end of the rudder, so that the tiller 1 extends generally horizontally forward towards the cockpit 23. The distal end 3 is adapted to receive a handle, which may simply comprise a suitable handgrip, although in the present example it is fitted with an articulated tiller extension rod 15 which allows the user to control the tiller from a variety of positions within the boat. p The upper side 5 of the tiller midsection 4 comprises a rounded, axially elongate ridge 6 which defines two oppositely sloping, ramped surfaces 7, 7′. Opposite the ridge, on the lower side 8 of the tiller, an axially elongate recess 9 is formed, defining two oppositely sloping, downward re-entrant surfaces 10, 10′. A metal wear plate 11 is fixed to the upper side 5 of the tiller at the point where it contacts the standing part 30′ of the traveller rope 30 and the traveller block assembly 31, 31′.

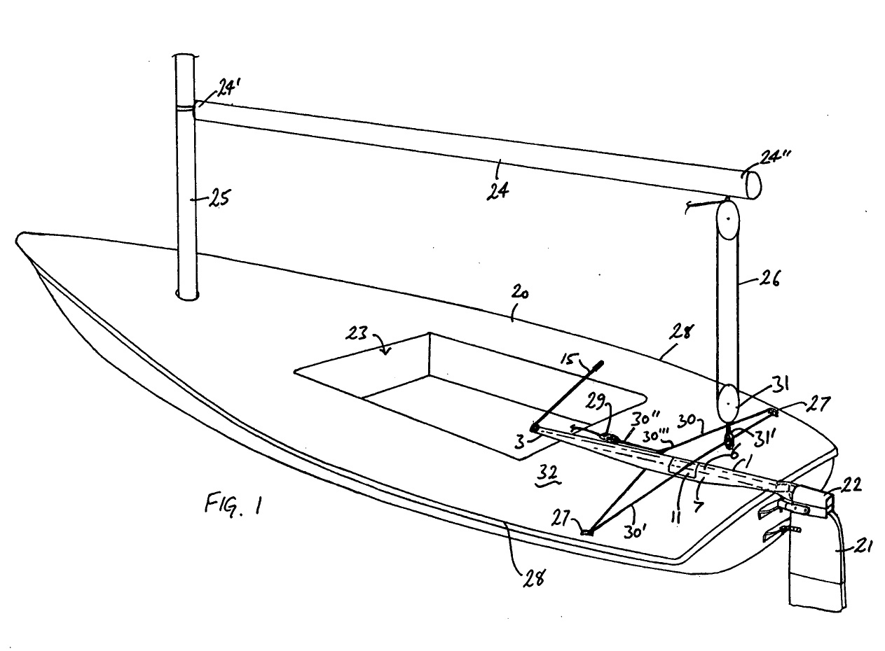

Desirably, the midsection 4 of the tiller is widened transversely to its longitudinal axis, in the generally horizontal direction when installed as shown in FIG. 1, which broadens the ramped upper sloping surfaces 7, 7′ and thus reduces the angle between them. This, together with the narrow lower edges 12, 12′ of the midsection 4 which slip underneath the lower block 31′, makes it easier for the traveller block assembly to ride up and over the tiller 1, as well as increasing the lateral stiffness of the tiller. For optimal lateral stiffness and economy of weight and materials, the ridge and recess preferably extend for between 50% and 67% of the total length of the tiller.

In the racing sailboat shown in FIG. 1, the boom 24 is supported at its proximal end 24′ by the mast 25, and restrained at its distal end 24″ by the mainsheet 26. The mainsheet 26 is restrained in turn by the upper block 31 of the traveller block assembly, whose lower block 31′ runs freely along the standing part 30′ of the traveller rope 30 between the fairleads 27 which are mounted respectively on either gunwhale 28. The free end 30″ of the traveller rope is led underneath the tiller and through a loop in the other end 30″ of the same rope, and then secured to the traveller rope cleat 29 on the deck 32.

The standing part 30′ of the traveller rope is stretched as tightly as possible over the tiller 1 as shown, in order to obtain the best performance from the sail, so that as the boom swings the lower block 31′ of the traveller block assembly crosses the tiller as it passes from one fairlead 27 to the other. The metal wear plate 11 is advantageously provided on the upper surface of the tiller so as to protect the tiller from damage at this point.

The reduced vertical profile of the tiller midsection 4, which is made possible by the additional rigidity provided by the re-entrant surfaces 10, 10′, reduces the angle of the standing part 30′ of the traveller rope where it passes over the tiller, and hence makes it possible to obtain more tension in the traveller rope while reducing friction and impact between the tiller 1, the traveller rope and the traveller block assembly. Since the tiller midsection is more rigid, it is also possible to mount the tiller 1 closer to the deck 32 without causing it to hit the deck or the traveller rope cleat 29 under the downward pressure of the standing part 30′ of the traveller rope.

Preferably, the tiller 1 is formed as a hollow moulding from carbon fibre, which makes it particularly light and hence very responsive. Conveniently, the ridge and recess form generally an inverted V-shape when considered in transverse section, and each of the upper sloping surfaces 7, 7′ is generally parallel with the corresponding respective re-entrant surface 10, 10′, and this is found to give a particularly rigid construction. Alternatively, the tiller may be formed as a hollow moulding from other materials, or alternatively may be made from solid material, in which case the recess 9 has the additional advantage of reducing its overall weight.

In summary, embodiments provide a carbon fibre sailboat tiller, in particular for a sailboat having a traveller rope which passes across the tiller, which has a midsection comprising an elongate, rounded ridge on its upper surface and a corresponding, inverted V-shaped groove on its lower surface. The ridge defines a ramped profile which minimises interference with the traveller block assembly, while the groove defines re-entrant surfaces which stiffen the tiller and allow its vertical profile as well as its clearance from the deck to be reduced. Preferably the midsection of the tiller is widened laterally, and the ridge and recess extend for between 50% and 67% of the total length of the tiller.

Rather than a single elongate recess 9, two or more generally parallel, axially elongate recesses separated by one or more ridges may be formed on the lower side 8 of the tiller. The tiller may also be used on boats other than sailboats.

Alternative embodiments using the principles disclosed will suggest themselves to those skilled in the art upon studying the foregoing description and the drawings. It is intended that such alternatives are included within the scope of the invention, which is limited only by the claims.

What I claim is:

1. A tiller for attachment to a rudder of a boat,
the tiller comprising an elongate bar having a proximal end, a distal end, and a midsection therebetween,
the midsection having an upper side which faces upwards in use
and a lower side which faces downwards in use,
the proximal end being adapted for attachment to the rudder;
wherein the upper side of the midsection comprises an axially elongate ridge,
and the lower side of the midsection comprises at least one axially elongate recess.

2. A tiller according to claim 1, wherein the elongate ridge divides the upper side into two oppositely sloping upper surfaces, and the elongate recess divides the lower side into two oppositely sloping downward surfaces.

3. A tiller according to claim 1, wherein the ridge and recess are generally V shaped.

4. A tiller according to claim 1, wherein the ridge and recess extend for between 50% and 67% of the length of the tiller.

5. A tiller according to claim 1, wherein a wear plate is provided on the upper side of the tiller.

6. A tiller according to claim 1, wherein the midsection of the tiller is widened horizontally and transversely to its axis.

7. A tiller according to claim 1, wherein the tiller comprises a hollow moulding.

8. A tiller according to claim 7, wherein the tiller is moulded from carbon fibre.
